(19) United States
(12) Patent Application Publication
(10) Pub. No.: US 2013/0269805 A1
(43) Pub. Date: Oct. 17, 2013

(54) UNPLUGGED BUBBLE BEVERAGE MACHINE

(71) Applicants: Teh-Hsin WANG, Huwei (TW); Chin-Tsang YEH, Huwei (TW); Kai-Pomr HUANG, Huwei (TW)

(72) Inventors: Teh-Hsin WANG, Huwei (TW); Chin-Tsang YEH, Huwei (TW); Kai-Pomr HUANG, Huwei (TW)

(21) Appl. No.: 13/464,006

(22) Filed: May 4, 2012

(30) Foreign Application Priority Data
Apr. 12, 2012 (TW) 101206652

(51) Int. Cl. F16K 24/00

(52) U.S. Cl. 137/588

(57) ABSTRACT

An unplugged bubble beverage machine is disposed with a containing chamber and a cover body capable of sealing the containing chamber, wherein the cover body is disposed with a vent communicating with the containing chamber to contain the relief device. An interval is disposed between the vent and the relief device. The relief device can be pushed by gas inside the containing chamber to vertically move inside the vent, thereby achieving the effect of leaking gas inside the containing chamber.

### BACKGROUND OF THE INVENTION

1. Field of the Invention

The present invention generally relates to an unplugged bubble beverage machine, in particular to an unplugged bubble beverage machine capable of being leaked with gas inside the unplugged bubble beverage machine to have safety and application demand.

2. Description of the Related Art

Currently, conventional soda water supply devices are large units for business purposes such as a beverage vending machine. This device is merely disposed with a containing chamber and a freezing system inside the machine. The containing chamber is used for containing soda water or other beverage, and the beverage or soda water preserved in the containing chamber is frozen and preserved by the freezing system and then is outputted to consumers for drinking via output tubes. The foregoing device can be supplied to the consumers to take soda water or other beverage, other bottle beverages or canned soft drinks can be satisfied with the consumers.

However, this soda water still has the following defects although it is widely supplied.

1. Consumers still need to buy this soda water to cause time consuming. To frequently avoid purchasing, consumers sometimes buy this soda water at a great quantity to cause space occupation. If this soda water can be produced by themselves, and its convenience can be greatly improved.

2. Soda water sale in the market is usually blended by companies, and its flavor, sweetness, air containing, and so on may not match the optimum demand of consumers to cause limited options for consumers.

3. In bottle or canned containing soda water that is externally bought, its container is difficult to be effectively repeated and used. A great quantity of beverage consuming can be seen to cause serious environmental protection problem due to lots of container. Even if these containers can be recycled at high efficiency, their costs are still amazing.

In view of the foregoing shortcomings existing in bottle or canned soda water for sale in the vending machines or markets and great demands of soda water, the inventor(s) of the present invention based on years of experience in the related industry to conduct extensive researches and experiments in developing family soda water producing devices, and finally developed an unplugged bubble beverage machine having novel structure and convenience and safety application demand.

### SUMMARY OF THE INVENTION

Therefore, it is a primary objective of the present invention to provide an unplugged bubble beverage machine capable of being leaked with gas inside the machine to have safety and application demand.

To achieve the foregoing objective, the present invention provides an unplugged bubble beverage machine disposed with a containing chamber and a cover body capable of sealing the containing chamber. The cover body is disposed with an intake valve set to place gas inside the containing chamber from the intake valve set. A relief device is further disposed to the cover body, wherein the cover body is disposed with a vent communicating with the containing chamber to contain the relief device. An interval is disposed between the vent and the relief device. The relief device has a gastight ring relatively located below the interval. The cover body has a first through hole relative to the vent and communicating with the vent. The bottom of the relief device is disposed with an airflow channel communicating with the containing chamber. The relief device has a second through hole relative to the interval and communicating with the airflow channel. An end of the airflow channel is disposed with an airflow valve.

Gas enters the containing chamber through the intake valve set. If placed excessive gas is at a saturated state, gas can push the airflow valve to open it and enter the airflow channel to sequentially exhaust through the second through hole and the first through hole. When gas is exhausted and achieves a saturated and predetermined pressure, the airflow valve is closed such that gas is unable to be leaked via the first through hole from the containing chamber.

While performing pressure relief, the relief device can be downwardly pressed and pushed to allow the relief device to downwardly move such that the interval is exposed to the containing chamber. Gas within the containing chamber can be leaked out by the first through hole from the interval to achieve the effect of leaking gas within the containing chamber.

To achieve the foregoing objective of the present invention, the relief device comprises a plug cover, a rod body and a first flexible component. The rod body is disposed below the plug cover. The airflow channel is located at a bottom of the rod body. The first flexible component is fit to an outside of the rod body and located relatively below the plug cover.

To achieve the foregoing objective of the present invention, the relief device further has a bottom seat. The bottom seat is disposed at a bottom of the rod body. The bottom seat is disposed with a fourth through hole communicating with the airflow channel.

To achieve the foregoing objective of the present invention, the airflow valve is disposed with a second flexible component and a sphere valve. The sphere valve is pushed by the second flexible component to press the fourth through hole.

To achieve the foregoing objective, a plurality of screw threads corresponding to each other is disposed to the bottom seat and the rod body.

To achieve the foregoing objective, the plug is disposed with a head and a ring wall located below the head. The ring wall is disposed with a slot. A top of the rod body is disposed with a brake portion to fasten and brake the slot

To achieve the foregoing objective, the relief device is further disposed with another gastight ring relatively located on the interval.

To achieve the foregoing objective, the vent of the cover body is further disposed with a fastening collar. The fastening collar is relatively fit to an outside of the the rod body of the relief device and relatively below the first flexible component. The fastening collar is fastened in the vent. The fastening collar is disposed with a third through hole. The third through hole communicates with the first through hole.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a structural three-dimensional diagram of an unplugged bubble beverage machine according to a preferred embodiment of the present invention;

FIG. 2 is a structural cross-sectional view of an unplugged bubble beverage machine according to a preferred embodiment of the present invention;

FIG. 3 is a structural three-dimensional diagram of a relief device according to a preferred embodiment of the present invention;

FIG. 4 is a structural decomposition drawing of a relief device according to a preferred embodiment of the present invention;

FIG. 5 is a partial enlarged diagram of a relief device according to the present invention;

FIG. 6 is a schematic diagram of an unplugged bubble beverage machine according to a preferred embodiment of the present invention; and

FIG. 7 is an application enlarged diagram of an unplugged bubble beverage machine according to a preferred embodiment of the present invention.

### DETAILED DESCRIPTION OF THE PREFERRED EMBODIMENTS

The technical content of the present invention will become apparent by the detailed description of the following embodiments and the illustration of related drawings as follows.

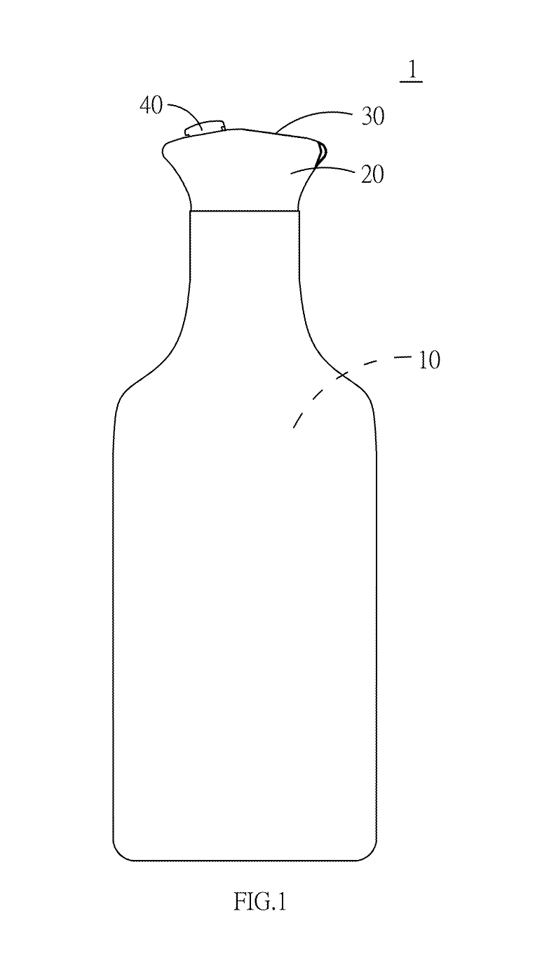

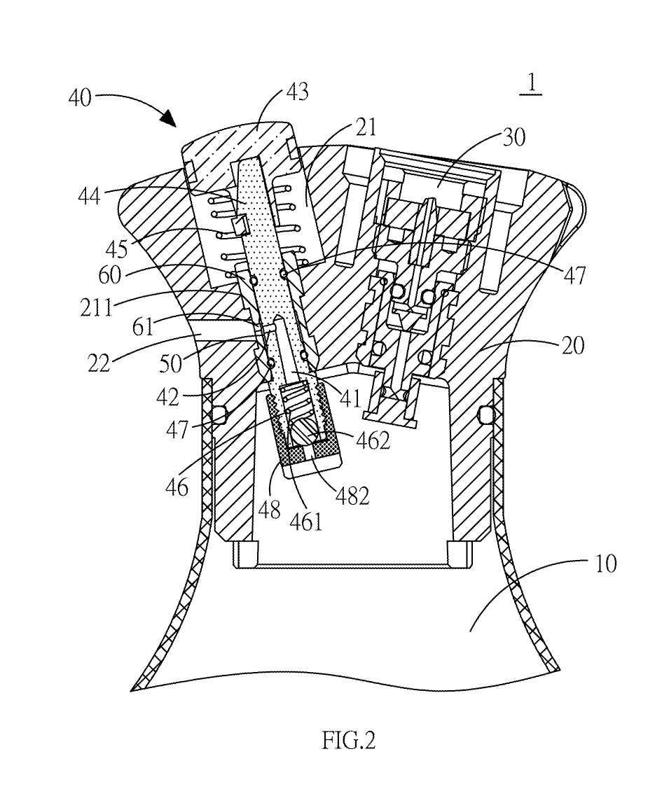

With reference to FIG. 1 and FIG. 2 for a structural three-dimensional diagram of an unplugged bubble beverage machine according to a preferred embodiment of the invention and a structural cross-sectional drawing of an unplugged bubble beverage machine according to a preferred embodiment of the invention are depicted. The unplugged bubble beverage machine 1 is disposed with a containing chamber 10 and a cover body 20 capable of sealing the containing chamber 10. The cover body 20 is disposed with an intake valve set 30 such that gas inside the containing chamber 10 can enter from the intake valve set 30. In addition, a relief device 40 is disposed to the cover body 20.

The cover body 20 is disposed with a vent 21 communicating with the containing chamber 10 to contain the relief device 40. The cover body 20 has a first through hole 22 relative to and communicating with the vent 21. An interval 50 is disposed between the vent 21 and the relief device 40. The relief device has a gastight ring 47 disposed below the interval 50. A bottom of the relief device 40 is disposed with an airflow channel 41 communicating with the containing chamber 10. The relief device 40 is disposed with a second through hole 42 communicating with the airflow channel 41 and relative to the interval 50. The end of the airflow channel 41 is disposed with an airflow valve 46 as shown in the embodiment. The airflow valve 46 is disposed with a second flexible component 461 and a sphere valve 462.

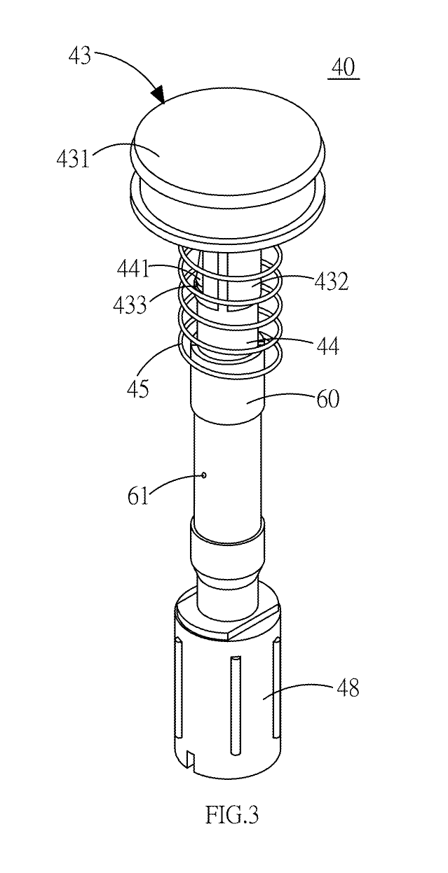

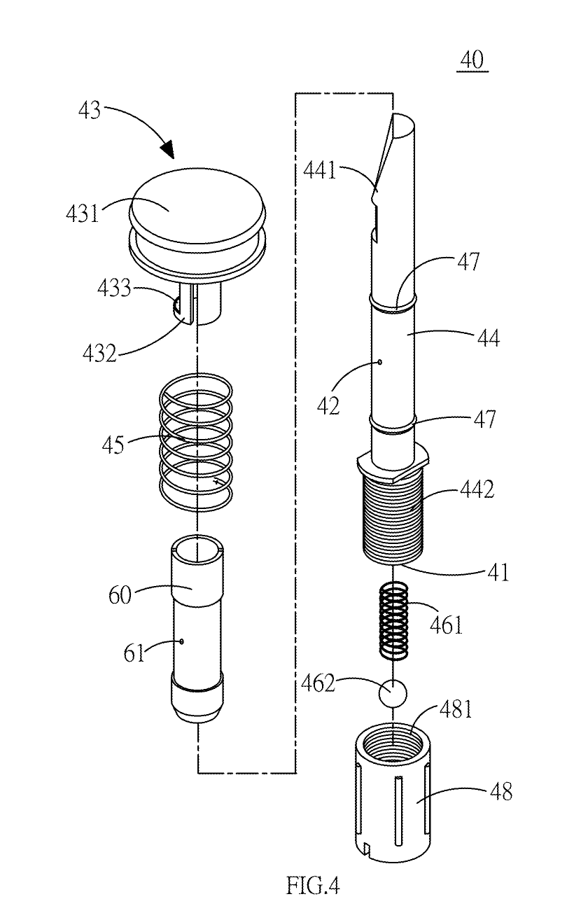

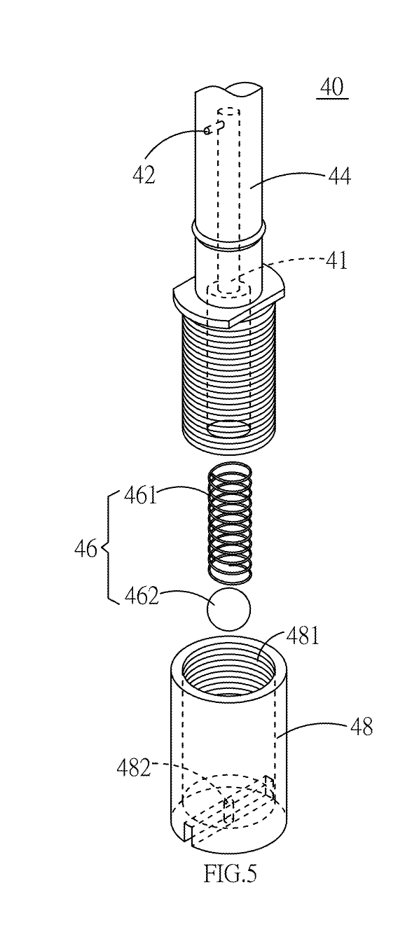

With reference to FIG. 3 to FIG. 5, the relief device 40 comprises a plug cover 43, a rod body 44 and a first flexible component 45. The rod body 44 is disposed below the plug cover 43. The airflow channel 41 is disposed at the bottom of the rod body 44. The first flexible component 45 is fit to an outside of the rod body 44 and is relatively below the plug cover 43.

While in assembly, the plug cover 43 is disposed with a head 431 and a ring wall 432 located below the head 431. The ring wall 432 is disposed with a slot 433. A top of the rod body 44 has a brake portion 441 for fastening inside the slot 433 to fasten the rod body 44 below the plug cover 43. The first flexible component 45 is fit to an outside of the rod body 44 to complete the assembly of the relief device 40. The relief device 40 that is completely assembled is placed in the vent 21. An inside of the vent 21 is disposed with a fastening wall 211 for fastening the relief device 40, wherein the inside of the vent 21 of the cover body is further disposed with a fastening collar 60. The fastening collar 60 is fit to the an outside of the rod body 44 and below the first flexible component 45. The fastening collar 60 can restrict the first flexible component 45 between the head 431 of the plug cover and the fastening wall 211. The fastening collar 60 is disposed with a third through hole 51. The third through hole 61 communicates with the first through hole 22. In addition, the relief device is further disposed with another gastight ring 47 relatively located on the interval 50.

Moreover, the relief device 40 is further disposed with a bottom seat 48. The bottom seat 48 is disposed at the bottom of the rod body 44. A plurality of screw threads 481, 442 corresponding to each other is respectively disposed at the bottom seat 48 and the rod body 44 to allow the bottom seat 48 to mutually screw and fasten the rod body 44. The bottom of the bottom seat 48 is disposed with a fourth through hole 482. The fourth through hole 482 communicates with the airflow channel 41. The sphere valve 462 of the airflow valve is pushed by the second flexible component 461 to press the fourth through hole 482.

While in use, as shown in FIG. 2, gas enters the containing chamber 10 from the intake valve set 30. If placed excessive gas is at the saturated state, gas can push the sphere valve 462 from the fourth through hole 482 to open the airflow valve 46 and enter the airflow channel 41 such that gas can be exhausted by the second through hole 42, the third through hole 51 and the first through hole 22 sequentially. When gas is exhausted and achieves at the saturated and predetermined pressure, the sphere valve 462 is descended to close the airflow valve 46 to seal the fourth through hole 482 such that gas is unable to leak via the first through hole 22 from the containing chamber 10.

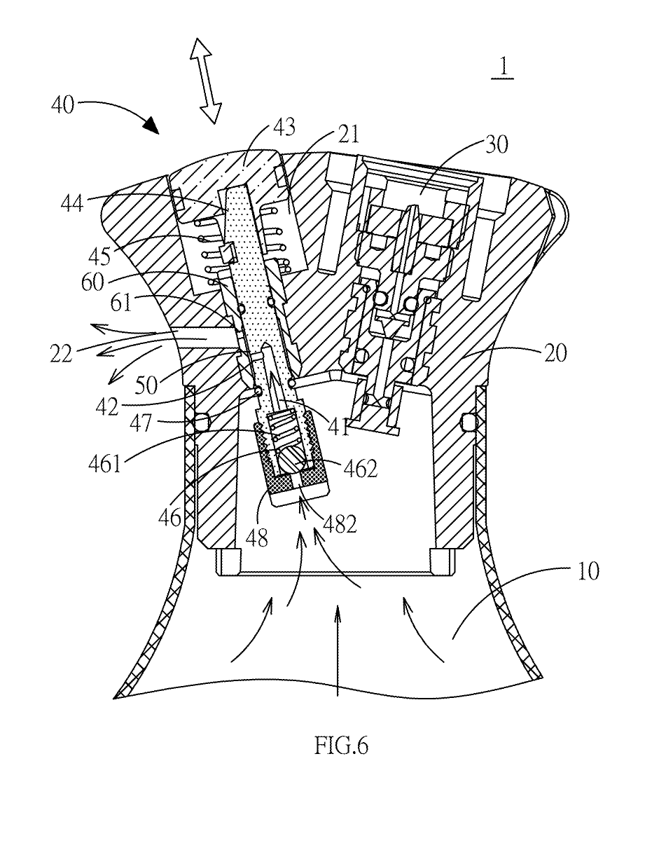

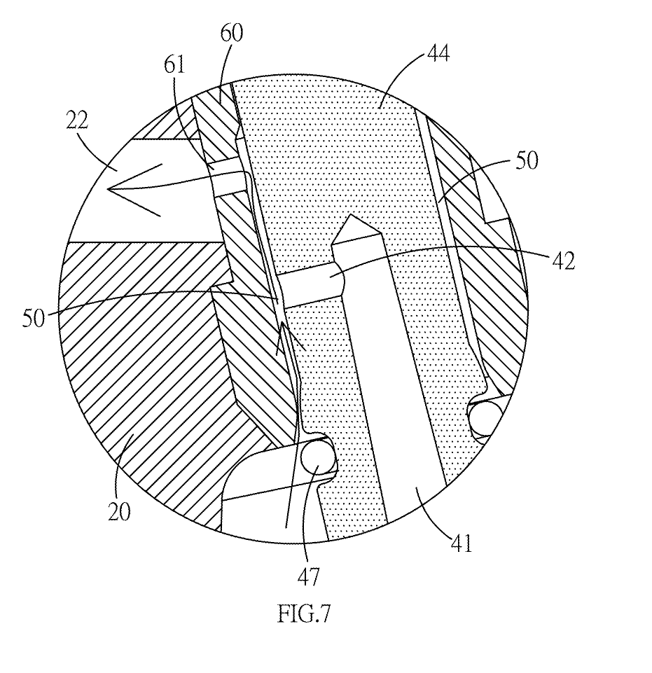

While performing the pressure release, the head 431 of the plug cove of the relief device can be pushed and pressed as shown in FIG. 6 and FIG. 7, the interval 50 is exposed to the containing chamber 10 to allow gas inside the containing chamber 10 to sequentially leak from the third through hole 61 and the first through hole 42, thereby achieving the effect of leaking gas inside the containing chamber 10.

Moreover, the degree of mutually screwing the bottom seat 48 and the rod body 44 can be controlled to control the loosening and tightening degrees of pressing the sphere valve 462 on the fourth through hole 482 so that flow quantity of gas entering the airflow channel 41 via the fourth through hole 482 can be regulated.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. An unplugged bubble beverage machine comprising:
a containing chamber;
a cover body disposed to the containing chamber and capable of sealing the containing chamber, the cover body disposed with a vent communicating with the containing chamber, the cover body disposed with a first through hole relative to the vent and communicating with the vent;
an intake valve set disposed to the cover body to place gas inside the containing chamber via the intake valve set;
a relief device disposed to the vent of the cover body, an interval disposed between the vent and the relief device, the relief device having a gastight ring relatively located below the interval, a bottom of the relief device disposed with an airflow channel communicating with the containing chamber, the relief device further disposed with a second through hole communicating with the airflow channel and relative to the interval, an end of the airflow channel disposed with an airflow valve.

2. The unplugged bubble beverage machine of claim 1, wherein the relief device further comprises:
a plug cover;
a rod body disposed below the plug cover, the airflow channel located at a bottom of the rod body and
a first flexible component fit to an outside of the rod body and relatively located below the plug cover.

3. The unplugged bubble beverage machine of claim 2, wherein the relief device is further disposed with a bottom seat, and the bottom seat is disposed at a bottom of the rod body, and the bottom seat is disposed with a fourth through hole communicating with the airflow channel.

4. The unplugged bubble beverage machine of claim 3, wherein the airflow valve is disposed with a second flexible component and a sphere valve, and the sphere valve is pushed by the second flexible component to press the fourth through hole.

5. The unplugged bubble beverage machine of claim 3, wherein a plurality of screw threads corresponding to each other is disposed between the bottom seat and the rod body.

6. The unplugged bubble beverage machine of claim 2, wherein the plug cover is disposed with a head and a ring wall located below the head, and the ring wall is disposed with a slot, and a top of the rod body is disposed with a brake portion to brake and fasten at the slot.

7. The unplugged bubble beverage machine of claim 2, wherein the relief device is further disposed with another gastight ring relatively located on the interval.

8. The unplugged bubble beverage machine of claim 2, wherein the vent of the cover body is further disposed with a fastening collar, and the fastening collar is relatively fit at an outside of the relief device and relatively located below the first flexible component, the fastening collar is fastened in the vent, and the fastening collar is disposed with a third through hole, and the third through hole communicates with the first through hole.
